(19) United States
(12) Patent Application Publication
(10) Pub. No.: US 2008/0300652 A1
(43) Pub. Date: Dec. 4, 2008

(54) Systems and Methods for Inducing Intelligible Hearing

(76) Inventors: Hubert H. Lim, Northville, MI (US); David J. Anderson, Ann Arbor, MI (US); James A. Wiler, Brighton, MI (US); Jamille F. Hetke, Brooklyn, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/592,916

(22) PCT Filed: Mar. 17, 2005
(86) PCT No.: PCT/US2005/009046

§ 371 Date: Aug. 25, 2008

Related U.S. Application Data
(60) Provisional application No. 60/553,884, filed on Mar. 17, 2004.

(51) Int. Cl. H04R 25/00

(52) U.S. Cl. 607/56

(57) ABSTRACT

The present invention comprises systems and methods for inducing auditory sensations in patients by stimulating the inferior colliculus of the mammalian midbrain. In some embodiments, the invention comprises an auditory prosthesis system comprising a microphone, a sound processor, a current stimulator, and one or more stimulating electrodes disposed in the inferior colliculus of a mammal. At least one of the stimulating electrodes may be comprised of one or more shanks, each shank comprised of one or more stimulation sites. In some embodiments, without limitation, the invention comprises methods of inducing auditory sensation in a mammal, comprising the steps of providing a microphone, a sound processor, and a current stimulator; providing one or more stimulating electrodes each comprised of two or more shanks, each shank comprised of one or more stimulation sites; disposing at least one stimulating electrode in the inferior colliculus of a mammal; and stimulating at least one isofrequency lamina of the inferior colliculus by applying an electrical signal through at least one of the stimulation sites.

### CROSS-REFERENCE TO RELATED APPLICATIONS

This application claims priority based on U.S. Provisional Patent Application No. 60/553,884, filed Mar. 17, 2004, which is hereby incorporated by reference in full.

### FIELD OF THE INVENTION

The present invention relates generally to the field of hearing loss and, more specifically, to systems and methods for restoring some auditory function by stimulating the inferior colliculus of the mammalian midbrain.

### BACKGROUND

Hearing loss, in whole or in part, can have profound implications for the subject of the loss. Consequently, significant efforts have been made to mitigate the effects of hearing loss by numerous means.

Attempts to induce sound perception via electrical stimulation of the auditory apparatus occurred as early as 1800 by Allessandro Volta, when he connected a group of batteries to two metal rods inserted in his ears and witnessed a sound that he compared to the boiling of thick soup. Since that time, researchers have attempted to induce or improve sound perception by acoustic amplification, bone conduction, and direct electrical stimulation of the auditory nerve. For patients suffering from conductive hearing loss, where the normal mechanical pathways for sound to reach and activate the hair cells of the cochlea have been compromised, acoustic amplification (i.e., conventional hearing aids) and bone conduction methods can be used to restore or at least partially improve auditory function.

However, these methods become ineffective for profoundly deaf patients suffering from sensorineural hearing loss, which is caused by the absence or destruction of the hair cells in the cochlea that convert the acoustic signal into electrical impulses transmitted along the auditory nerve to higher auditory centers. In these patients, direct stimulation of the auditory nerve can be performed to restore some auditory function and even induce intelligible speech perception.

One of the earlier auditory nerve implant systems was proposed by Doyle (U.S. Pat. No. 3,449,768), followed by numerous attempts by other researchers and inventors to improve what is now known as the cochlear implant. Although cochlear implants have been successful in restoring hearing sensations and even intelligible speech perception for some patients suffering from sensorineural hearing loss, they become ineffective for patients with damaged or missing auditory nerves. These include, as examples, patients suffering from neurofibromatosis type II and bilateral acoustic neuromas, and less frequently, patients with congenital missing auditory nerves or traumatic lesions of the auditory nerves. Without a viable auditory nerve, cochlear implants are unable to transmit electrical nerve impulses up to higher auditory centers. There also exist patients who have viable auditory nerves, but have unimplantable cochleae possibly due to ossification or other factors that make them ineligible for a cochlear implant.

Attempts at inducing auditory sensations by bypassing the auditory nerve and electrically stimulating other regions along the auditory pathway have been primarily focused on the cochlear nucleus of the brainstem. The motivation for stimulating the cochlear nucleus evolved from the necessity for tumor removal at that site in neurofibromatosis type II patients. Since tumor removal resulted in bilateral transection of the auditory nerves causing complete deafness in these patients, and since the cochlear nucleus was accessible during these procedures, there was little added risk for implanting an auditory prosthesis on the surface of the cochlear nucleus. These brainstem implants consist of a surface electrode with multiple stimulation sites that is placed on the surface of the cochlear nucleus within the lateral recess. Unfortunately, the success of these brainstem implants has been minimal with performance levels comparable to single channel cochlear implants (Otto et al., 2002). Possible factors affecting performance include the distorted anatomy and altered functional properties of the cochlear nucleus caused by the tumor or previous treatment including gamma knife therapy, poor electrode placement due to limited surgical visibility of the stimulation site and the distorted anatomy caused by the tumor, and the unfavorable and irregular tonotopic organization of the cochlear nucleus in relation to the plane of the surface electrode.

Furthermore, current cochlear implant subjects are unable to fully utilize the spectral information provided by all the stimulation sites on the cochlear electrode, perform poorly in noisy environments, and cannot effectively achieve music appreciation (Friesen et al., 2001). These limitations are partly caused by the inability to place the stimulation sites in direct contact with the auditory nerve fibers since the cochlear implant electrode is placed into the scala tympani while the auditory nerve fibers are located outside of this region within the modiolus. Due to the greater distance between the stimulation sites and the nerve fibers, activation thresholds are higher and spreading of activation across different fibers is increased, reducing the number of independent frequency channels of information available for stimulation. The extent of auditory nerve survival also affects the performance level across subjects.

In light of these and other limitations, improved systems and methods for hearing restoration that can lower thresholds and spread of activation, as well. as provide a more consistent and effective means for transmitting auditory information to higher perceptual centers across patients compared to cochlear implants, would be beneficial for patients suffering from a wide range of hearing loss disorders. For deaf patients who cannot benefit from current auditory aid devices and prostheses, especially for neurofibromatosis type II patients, there is an unmet need for improved systems, methods, and devices for inducing auditory sensations and ultimately intelligible speech perception and music appreciation.

The present invention was developed in light of these and other drawbacks.

### SUMMARY

Without limiting its scope, in some embodiments, the invention comprises an auditory prosthesis system comprising a microphone, a sound processor, a current stimulator, and one or more stimulating electrodes disposed in the inferior colliculus of a mammal, wherein the invention differentially extracts one or more frequency components of a sound wave and differentially stimulates one or more regions of the inferior colliculus. Such mammals include, but are not limited to, humans. At least one of the stimulating electrodes may be comprised of one or more shanks, each shank comprised of one or more stimulation sites. A preferred stimulating electrode disposed in the inferior colliculus of a mammal may have five shanks, each shank having from 10 to 80 stimulation sites. The stimulation sites on each shank are linearly spaced from 40 to 400 micrometers apart, with each stimulation site having a surface area from 400 to 4000 square micrometers. In some embodiments, a plurality of stimulation sites may be configured for stimulation across and within different isofrequency laminae, and/or stimulation at different locations within the same isofrequency lamina, of the central nucleus of the inferior colliculus.

In some embodiments, without limitation, the invention comprises auditory prosthesis systems comprising a microphone, a sound processor comprising an encoder and a transmitter, a current stimulator that is implanted in a mammal and that comprises a receiver, and at least one stimulating electrode disposed in the inferior colliculus of the mammal, the electrode comprised of at least two shanks, each shank comprised of one or more stimulation sites, wherein the microphone senses sound vibrations and transmits a sound waveform to the sound processor, the sound processor decomposes the sound waveform into a stimulation sequence signal that is transmitted to the current stimulator, the current stimulator receives the stimulation sequence signal transmitted by the processor, decodes the signal into a differential stimulation sequences, and transmits the sequence to one or more stimulation sites on the stimulating electrode. In some embodiments, the invention comprises a processor that decomposes the sound waveform by at least one of frequency coding, temporal coding, and group coding.

In some embodiments, without limitation, the invention comprises methods of inducing auditory sensation in a mammal, comprising the steps of providing a microphone, a sound processor, and a current stimulator; providing one or more stimulating electrodes each comprised of two or more shanks, each shank comprised of one or more stimulation sites; disposing at least one stimulating electrode in the inferior colliculus of a mammal; and stimulating at least one isofrequency lamina of the inferior colliculus by applying an electrical signal through at least one of the stimulation sites. In some embodiments, the stimulating step comprises frequency coding, temporal coding, and group coding. Without limitation, the invention comprises methods of inducing auditory sensation in a mammal, comprising the steps of providing a microphone, a sound processor comprising an encoder and a transmitter a sound processor, and a current stimulator that is implanted in a mammal and that comprises a receiver, providing at least one stimulating electrode, the electrode comprised of at least two shanks, each shank comprised of one or more stimulation sites, disposing at least one stimulating electrode in the inferior colliculus of a mammal; and differentially stimulating at least one isofrequency lamina of the inferior colliculus by applying an electrical signal through at least one of the stimulation sites, wherein the microphone senses sound vibrations and transmits a sound waveform to the sound processor, the sound processor decomposes the sound waveform into a stimulation sequence signal that is transmitted to the current stimulator, the current stimulator receives the stimulation sequence signal transmitted by the processor, decodes the signal into a differential stimulation sequence, and transmits the sequence to one or more stimulation sites on the stimulating electrode.

The invention also comprises other systems and methods, including without limitation, methods for placement and implementation of embodiments of the invention. Other aspects of the invention will be apparent to those skilled in the art after reviewing the drawings and the detailed description below.

### BRIEF DESCRIPTION OF THE DRAWINGS

The present invention will now be described, by way of example, with reference to the accompanying drawings, in which:

FIG. 1 is a diagram of one embodiment of the invention, without limitation, comprising a prosthetic system with four main components: microphone, processor (sound processor/encoder/transmitter), stimulator (receiver/decoder/stimulator), and stimulating electrode.

FIG. 2 is a data plot corresponding to spike activity recorded from different frequency regions within the primary auditory cortex (A1) in response to stimulation of different frequency regions within the central nucleus (ICC) of the inferior colliculus.

FIG. 3 is a data plot corresponding to the extent of spreading (A1 Image Width) along the tonotopic gradient of A1 in response to stimulation in the ICC or cochlea for varying stimulus levels.

FIG. 4 is a diagram of a stimulating electrode inserted into the central nucleus (ICC) of the inferior colliculus which is shaped similar to an onion consisting of two-dimensional curved isofrequency layers.

FIGS. 5(A)-(B) are histograms corresponding to the spike activity recorded from a certain frequency region within A1 in response to electrical stimulation of a different site location within the same isofrequency lamina in the ICC.

FIG. 6 is a plot corresponding to Ratio values for varying stimulus levels across five different animals where a Ratio value less than one indicates that stimulation of more rostral sites along the isofrequency dimension of the ICC elicit greater spreading of activation along the tonotopic gradient of A1.

FIG. 7 is a plot showing eleven different columns of dots where each column corresponds to a different electrode placement within ICC labeled by the abscissa and each dot corresponds to the evoked potential magnitude recorded in A1 in response to stimulation of each of the eight sites along an electrode.

FIG. 8 is a diagram of a preferred configuration of a three-dimensional stimulating electrode with 5 shanks comprising some embodiments of the invention.

FIGS. 9(A)-(C) are diagrams of some alternative three-dimensional electrode configurations of stimulating electrodes.

FIG. 10 is a flow chart of the processing strategy of one embodiment of the invention, without limitation.

### DETAILED DESCRIPTION

In some embodiments, without limitation, the invention comprises a prosthetic system for restoring some auditory function in mammalian patients suffering from partial or total hearing loss. In accordance with the invention, the inferior colliculus of the mammalian midbrain is a site of electrical stimulation for inducing auditory sensations in order to enhance, as some examples only, speech perception and music appreciation.

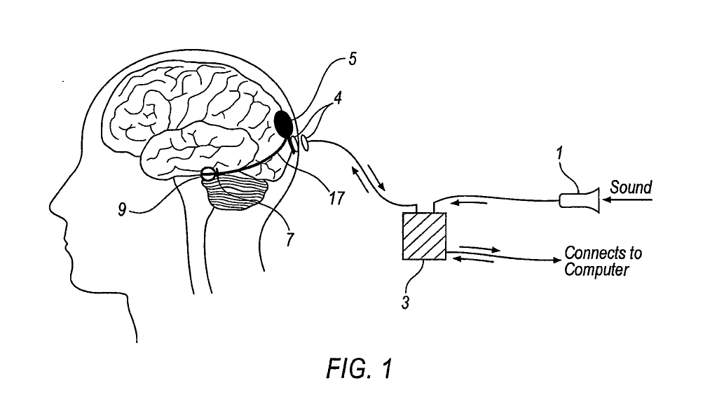

Without limiting the scope of the invention, as shown in the embodiment of FIG. 1, the invention comprises an auditory prosthesis system including four main components: a microphone 1; a processor 3 (sound processor/encoder/transmitter); a stimulator 5 (receiver/decoder/stimulator); and a stimulating electrode 7 disposed in the inferior colliculus 9. In general, sound will be recorded by the microphone 1 onto the processor 3. The processor 3 will decompose the sound into a stimulation sequence that will be used to control the stimulator 5. The processor will convert this stimulation sequence into a radiofrequency code to be transmitted via telemetry 4 to the receiver, which is part of the stimulator 5 that is implanted into the head of the patient. The transmitter is connected to the processor 3 via a cable and is magnetically held together in contact with the receiver portion of the stimulator 5 across the skin. The stimulator 5 will then receive this radiofrequency code and decode it into the correct stimulation sequence. The stimulator 5 will then stimulate the corresponding sites on one or more stimulating electrodes 7 placed in the inferior colliculus 9 in the correct temporal and spatial pattern based on the decoded stimulation sequence. Each component is discussed in more detail below.

As background, the inferior colliculus is a highly organized stricture in the mammalian brain that is irregularly rounded with a diameter of about 6 to 7 mm in all directions (Geniec and Morest, 1971; Moore, 1987; Winer and Schreiner, 2005). It receives almost all ascending projections from the brainstem. Thus, by stimulating the inferior colliculus in an appropriate manner, it is possible to transmit to higher auditory centers most of the information required for speech perception and music appreciation.

The inferior colliculus consists of several subdivisions, including the central nucleus (ICC), dorsal cortex, lateral cortex, and caudal cortex. In particular, the ICC 11 is about two-thirds the size of and located more centrally within the inferior colliculus. The ICC has a well-defined tonotopic organization spanning the entire frequency range of hearing, thus serving as a possible site for an auditory prosthesis.

Sound can be represented as a linear summation of different frequency components (Fourier Representation). The ability to extract these frequency components from the sound wave and stimulate different regions within the ICC that elicit percepts relating to these frequencies provides a means for restoring some auditory function in deaf patients. Because the ICC has a systematic organization of neural elements, where neurons sensitive to low frequency sounds are generally represented dorsolaterally and higher frequency sounds are represented more ventromedially, the different regions within the ICC may be systematically stimulated to elicit different frequency percepts. Although the anatomical and physiological organization of the ICC suggest that frequency-specific stimulation may be achieved in the ICC, the unnatural effects of electrically stimulating neural elements makes it difficult to predict if frequency-specific stimulation will actually be achieved in the ICC.

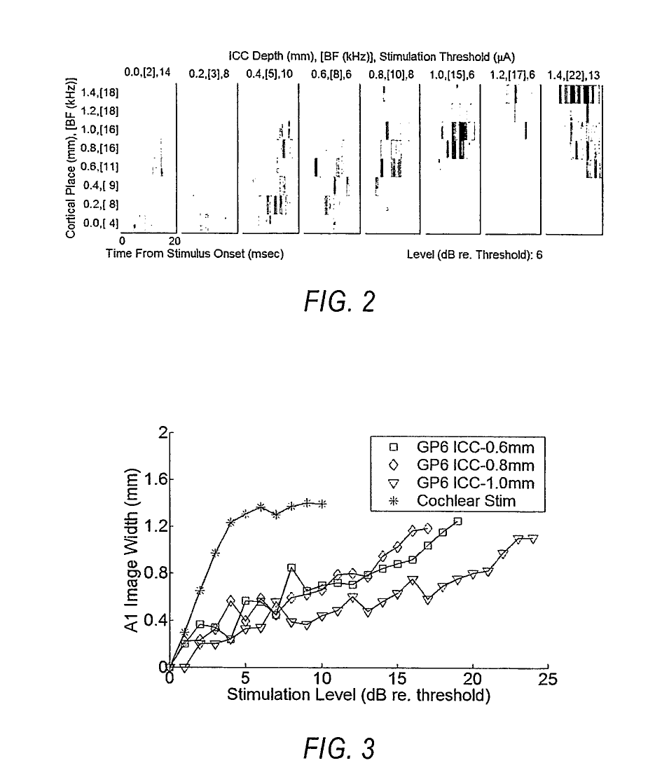

We have demonstrated that in fact frequency-specific stimulation is achievable in the ICC as measured by activation patterns recorded in the primary auditory cortex (A1) in a guinea pig animal model. FIG. 2 demonstrates how stimulation of a low frequency region in the ICC elicits activation in a low frequency region of A1, while stimulation of a higher frequency region in the ICC elicits activation in a higher frequency region in A1 (Lim and Anderson, 2003). In FIG. 2, each plot corresponds to a site located in a certain frequency region within the ICC labeled by BF. The ordinate corresponds to sites located in different frequency regions within A1 also labeled by BF. The colorscale corresponds to total spike rate where darker indicates greater spike activity. The stimulus was a single monopolar pulse repeated 40 times on each ICC site at a level of 6 dB above threshold.

In order to assess the extent of localization of these A1 activation patterns, we compared the spreading of activation along the tonotopic axis of A1 caused by ICC stimulation with that of cochlear stimulation using the same stimulus and recording parameters. FIG. 3 shows how ICC stimulation achieves significantly more localized activation in A1 compared to cochlear stimulation. A1 Image Width is a measure of activation spread along the tonotopic gradient of A1 in response to stimulation of a given ICC site or cochlear site (for calculation details see Bierer and Middlebrooks, 2002). A1 Image Width is plotted as a function of stimulation level above threshold for three different ICC sites and for one typical cochlear stimulation site (cochlear stimulation data taken from Bierer and Middlebrooks, 2002). FIG. 3 shows that activation spread in A1 increases as the stimulation level increases, and that cochlear stimulation causes significantly greater spreading than ICC stimulation.

Not only does ICC stimulation achieve more localized, frequency-specific activation compared to cochlear stimulation, but it also achieves significantly lower thresholds of activation which is important for minimizing battery consumption of any prosthesis and for preventing neural tissue damage in response to prolonged periods of electrical stimulation. Based on our results, ICC stimulation thresholds tend to be about 10-15 μA, which is more than three-fold lower than that of cochlear stimulation (Bierer and Middlebrooks, 2002).

These results are evidence that ICC stimulation can in fact systematically activate different frequency channels of information transmitted to higher auditory centers, and in a manner that achieves lower thresholds and more localized activation compared to cochlear stimulation. Therefore, ICC stimulation should improve perceptual detection of a greater number of frequency channels of information with reduced energy requirements compared to cochlear stimulation.

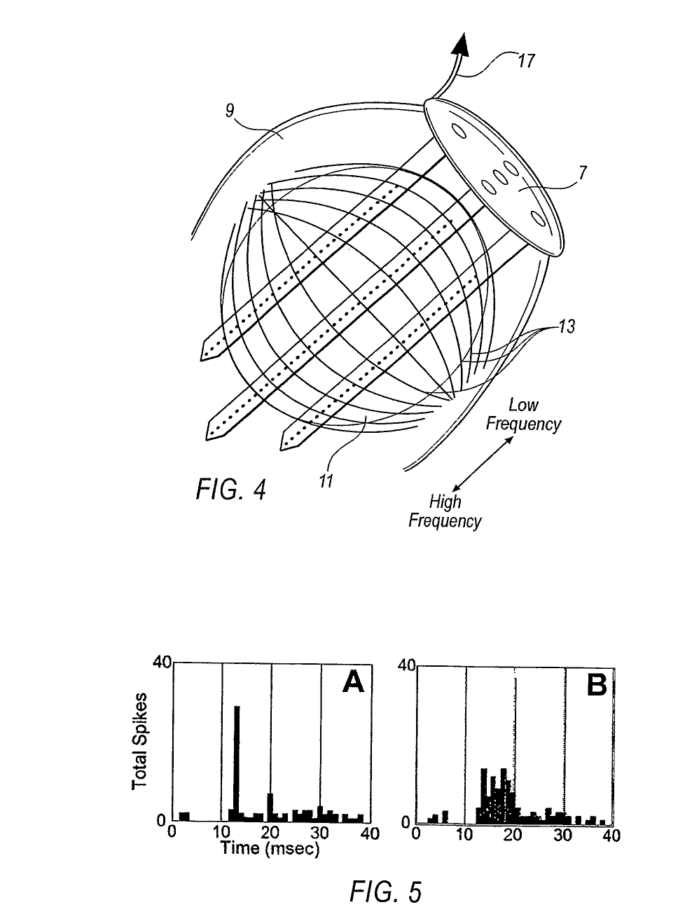

In addition to frequency features, preservation of the temporal variations in the amplitude of the sound is also important for speech recognition and music appreciation. The ICC 11 of the inferior colliculus 9 is shaped similar to an onion consisting of two-dimensional curved layers 13 (see FIG. 4). Each of these layers can be considered as an isofrequency lamina consisting of neurons and fibers most sensitive to approximately the same frequency or a small range of frequencies. As discussed above, frequency-specific stimulation by stimulating electrode 7 is achievable in the ICC. However, there is added complexity of how sound is processed within each of these isofrequency laminae. A few hypotheses suggest how some of the important temporal features of sound, such as pitch and binaural cues, may be organized within these isofrequency layers.

It has been proposed that periodicity (usually <1 kHz), or amplitude modulation rate, is topographically organized along the mediolateral direction orthogonal to the dorsoventral tonotopic gradient of the ICC (Langner, 2004). Therefore it appears that periodicity pitch, which elicits a perceptual pitch that correlates with the temporal periodicity in the sound waveform, can be systematically elicited by electrically stimulating along the mediolateral dimension (perpendicular to the tonotopic axis) of the ICC simultaneously with, yet somewhat independently of, different frequency components. For higher rate temporal modulations and even aperiodic fluctuations such as rising and falling amplitudes in the sound waveform, ICC neurons have shown to encode for these variations using different temporal and spatial spiking representations.

There is also evidence that different regions within the brainstem associated with different binaural and monaural features of sound project to different regions within the ICC, resulting in what are known as segregated functional zones [Loftis et al., 2004]. These functional zones vary along an isofrequency lamina and even across different frequency layers. Therefore, location of stimulation within the ICC, both along the frequency and isofrequency dimensions, should affect the activation patterns and ultimately the perceptual effects elicited in the cortex.

Based on our results in a guinea pig model, we observe that stimulation of different locations within a given isofrequency lamina in fact elicit different, temporally distinct response patterns in A1 that may be coding for different temporal features of sound. FIG. 5 presents two different examples of observed response patterns. Each histogram (PSTH) in FIG. 5 corresponds to the spike activity recorded from a certain region within A1 (20 kHz region) in response to electrical stimulation of a different site location within the same isofrequency lamina in the ICC (20 kHz lamina). Stimulus was a single monopolar pulse repeated 40 times with an onset at 10 msec. FIG. 5 demonstrates how stimulation of different regions with an isofrequency lamina in the ICC causes different temporal patterns of spike activity on the same cortical site.

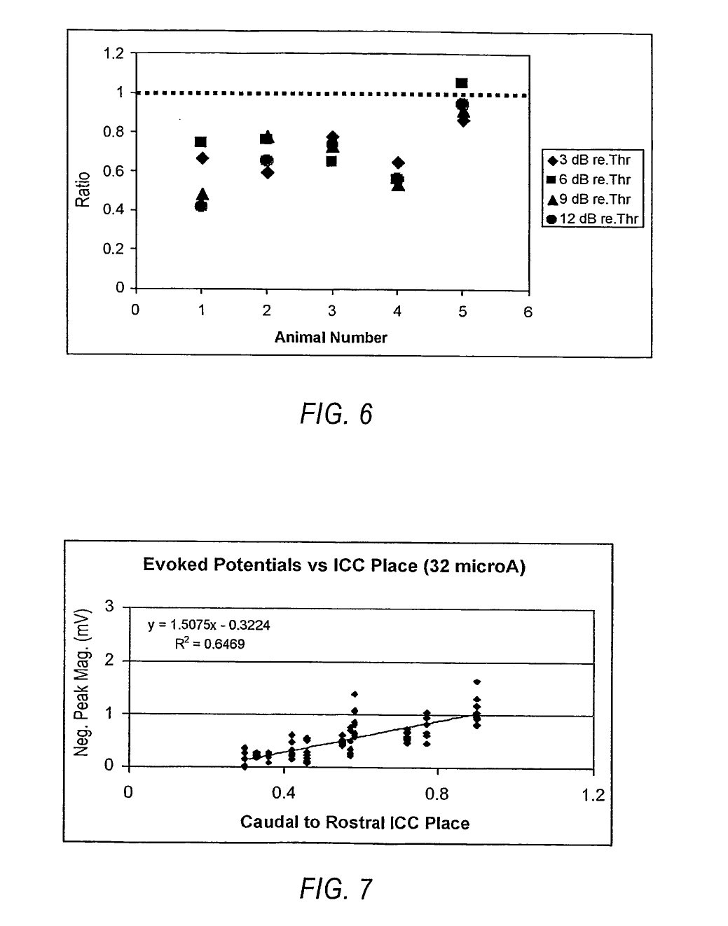

As shown in FIG. 6 and FIG. 7, we also observed that activation spread and evoked potential magnitude recorded in A1, respectively, systematically changed as a function of location of stimulation along the rostrocaudal dimension of the ICC.

FIG. 6 shows data obtained from five animals. For each animal, two shanks each with 8 sites were inserted into and aligned along the tonotopic axis of the ICC where one shank was located more rostrally along the isofrequency dimension than the other. Electrically stimulating a given ICC site elicited activity in A1. By recording this activity across the tonotopic gradient of Al, the extent of activation spread (A1 Image Width) caused by stimulating that ICC site was computed. For a given shank, A1 Image Width was calculated for each of the 8 sites. By averaging the A1 Image Width across all 8 sites, an average A1 Image Width was calculated for each shank. Ratio was then taken as the average A1 Image Width of the caudal (less rostral) shank divided by the average A1 Image Width of the more rostral shank. Therefore, a Ratio value of less than one indicated that greater spreading along the tonotopic gradient of A1 occurred when stimulating sites on the more rostral shank. In FIG. 5, Ratio is plotted for 5different animals and for 4 different stimulation levels for each animal. The location distribution of all the shanks across the 5 animals spanned the entire rostrocaudal extent of the ICC. Almost all Ratio values were less than one indicating that activation spread along the tonotopic gradient of A1 increases as stimulation location site along the isofrequency dimension of the ICC moves more rostrally. Thus, our results indicate that electrical stimulation not only along the frequency dimension but also along the rostrocaudal isofrequency dimension will affect and be necessary (though not claiming sufficient) to preserve the temporal and spectral features of sound that are important for speech perception and more complicated percepts such as music and sound localization.

FIG. 7 shows data from 6 different animals where a total of 11 different single-shank electrode placements within the ICC were made. Each electrode placement was located in a different rostrocaudal location along the isofrequency dimension of the ICC. Each electrode had 8 sites linearly spaced by 200 μm where each site was placed into a different frequency region but in the same rostrocaudal location. The rostrocaudal location of each shank was normalized to a scale from 0 to 1, where 0 corresponded to the caudal edge of the inferior colliculus and 1 corresponded to the division between the inferior colliculus and the superior colliculus. FIG. 7 shows 11 different columns of dots, each corresponding to different electrode placements labeled by the abscissa. There should be 8 dots per column but some dots are superimposed on top of each other. The ordinate specifies the peak magnitude of the negative deflection in the evoked potential recorded in A1 in response to stimulation of a given site in ICC. Each evoked potential was averaged over 40 trials of stimulation at a level of 32 μA. In general, stimulation of more rostral regions along the isofrequency dimension of the ICC elicited stronger evoked potentials in A1.

In selecting the ICC as the site for an auditory prosthesis, it is also important to assess the risk associated with deep brain implantation and stimulation. In comparison to the cochlear nucleus, where the current deep brain auditory prosthesis is being used, the inferior colliculus has greater surgical accessibility and can be directly exposed. In cases where patients suffer from neurofibromatosis type II, the inferior colliculus does not undergo anatomical and physiological changes due to the tumor. Thus, it is easier to identify than the cochlear nucleus during surgery and is not susceptible to adverse changes in how it processes sound. Undoubtedly, implanting a stimulating electrode into the ICC still involves deep brain surgery. Those of ordinary skill in the art will understand that fortunately successful techniques and implants have already been developed for deep brain stimulation used for tremor and pain suppression. Histopathological findings in brain tissue of deep brain stimulation patients indicate that chronic stimulation is safe and causes mild tissue reaction (Boockvar et al., 2000) suggesting the potential for safe, chronic usage of an auditory prosthesis implanted into the inferior colliculus.

In addition to the improvements and success of deep brain stimulation techniques over the past decade, significant advancements in silicon technology have provided the ability to develop three-dimensional stimulating electrodes with closely-spaced, densely-populated sites in a precise spatial configuration (Anderson et al., 1989; Bai et al., 2000; Gingerich et al., 2001; Wise et al., 2004). This technology provides a means for developing and fabricating a three-dimensional, chronic electrode that can stimulate closely-spaced, discrete regions along both the frequency and isofrequency dimensions of the ICC. It is also possible to utilize the three-dimensional structure to steer current between multiple sites to create what are known as “virtual” sites. Current steering has been demonstrated using a quadropolar configuration where one middle site is the current source and the two neighboring sites are the current sinks (Rodenhiser and Spelman, 1996). By altering the amount of current returning on each of the neighboring sites, it is possible to shift the focus of the current, or region of greatest potential gradient, in a continuous manner between the outer two sites. This method can be modified to incorporate multiple sites or even just two sites to control the overall pattern of activation within a specific region. Therefore, the silicon technology will not only enable stimulation of a greater number of discrete regions within the ICC in a three-dimensional pattern, but will also allow for greater flexibility in how current can be continuously steered throughout the ICC to activate the desired regions.

Thus, as part of the invention, without limitation, we have discovered unexpectedly that ICC stimulation may achieve low-threshold, localized, and frequency-specific stimulation and that a three-dimensional electrode may induce high levels of speech perception and more complicated percepts such as music and sound localization.

### EXAMPLES

Without limiting the scope of the invention, components of and methods for placement and implementation of some embodiments of the invention are described by way of example below.

In some embodiments, without limitation, the invention comprises a midbrain auditory prosthesis system of several main components, including without limitation:

Stimulating Electrode

A stimulating electrode 7 for placement in the inferior colliculus is made preferably from silicon according to advanced microfabrication techniques known to those of ordinary skill in the art. (As some examples only, see Anderson et al., 1989; Bai et al., 2000; Gingerich et al., 2001; Wise et al., 2004). Using these and similar techniques, an electrode may be designed and fabricated in a three-dimensional configuration with closely-spaced, densely-populated stimulation sites down to micron level precision. This example of material and technology is not intended to limit the scope of the invention but instead to exemplify how the three-dimensional electrode of some embodiments can be fabricated. Other materials can be also used to fabricate the desired stimulating electrode.

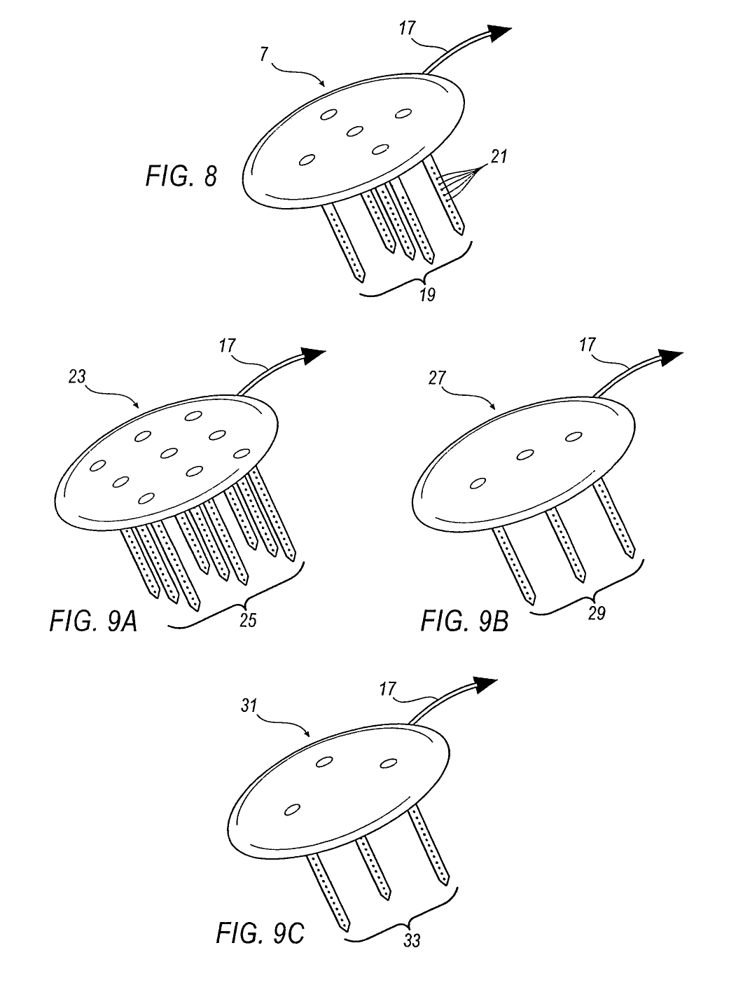

Without limiting the scope of the invention, FIG. 8 shows a preferred configuration of a three-dimensional stimulating electrode 7 of some embodiments. This exemplary electrode consists of five shanks 19. In some embodiments, it may be advantageous to increase the number and density of shanks to more effectively span the entire ICC. However, in doing so the risk involved with surgical implantation increases as well.

Based on our experimental results and the dimensions of the human ICC, in some embodiments, the preferred distance between each shank along the two major axes will be about 1 mm, though it can range between 0.5 to 2 mm depending on what distance achieves optimal performance in humans and minimizes tissue damage. Ideally, a larger distance between the shanks would allow more complete coverage of the ICC. However, if the shanks are too far apart, it will become more difficult to focus the current in a specific region between the shanks. If the shanks are too close together, the brain can be compressed during insertion and cause damage to the tissue.

The length of each shank will be about 5 mm (ranging between 3 to 7 mm) to ensure that when the top of the electrode is flush against the surface of the inferior colliculus, the shanks when inserted along the tonotopic axis of the ICC will span across all the frequency laminae as shown in FIG. 4. Along each shank, there can be anywhere from 10 to 80 stimulation sites 21 linearly spaced between 50 to 400 μlm depending on optimal performance in human. However, since each isofrequency lamina tends to span a width of about 100-200 μm (Winer and Schreiner, 2005), the linear spacing of about 100 μm is preferred to ensure at least one site resides within each frequency region.

It is preferred to have as many stimulation sites as possible that are closely spaced along each shank. However, increasing the number of sites increases complexity, especially in accommodating all the connection leads from the stimulator to each stimulation site. One solution is to have fewer sites with greater separation between sites and use current steering to create “virtual” sites in between the actual sites. In order to minimize the number of sites yet ensure effective coverage across the different frequency regions of the ICC, the preferred design is to have 20 sites per shank, each separated by 200 μm. This still results in a total of 100 sites.

Another preferred design is to have 40 sites per shank, each separated by 100 μm, assuming the energy requirements and connection leads to run all 200 sites can be sufficiently provided. It may be necessary to use fewer sites and shanks if the stimulator is unable to handle all the sites while still maintaining small enough dimensions for implantation into the head. It will also be possible to develop on-chip circuitry to allow for site switching where at a given time, only a set number of the total sites available can be used but with the ability to access any of the other sites as needed.

The area of each site will vary between 400 to 4000 μm² depending on a trade-off between amount of maximum current (charge density) required and the extent of localization needed. A preferred site area is about 2000 μm². As the amount of charge required increases, it may be necessary to increase the site area to minimize tissue damage. The geometry of the site can be circular or square and can be exposed on both sides to increase access to more neural elements in the ICC.

The electrode configuration and design of the invention is not limited to only the specified parameters presented above. Other three-dimensional electrode configurations, as shown in FIGS. 9(A)-(C), can be used. By way of examples only, a stimulating electrode 23 may be configured with a 3×3 array of shanks 25; an electrode 27 with a 3×1 array 29; or an electrode 31 with a triangular array 33. Single shank or bi-shank electrodes also comprise some embodiments. However, the ability to stimulate a greater number of neural elements within a given isofrequency lamina and to effectively use current steering will be altered.

Microphone

The microphone 1 may be used to sense the sound vibrations and record the sound waveform onto the processor 3. In order to improve signal-to-noise ratio as well as sound localization, directional microphones can be used where an array of microphones are placed in a specific spatial configuration. By using various blind source separation techniques on the multidimensional recorded signals, it is possible to separate and spatially localize different sources from the sound input. This is important for improving the quality of the sound by reducing the background noise and providing the implantee with a clearer representation of important features extracted from the recorded sound waveform. More importantly, ICC stimulation provides the ability to incorporate binaural information. Unlike for cochlear implants where neural stimulation is presented monaurally, ICC stimulation occurs higher up in the auditory pathway where binaural information is encoded. By using directional microphones, applying blind source separation techniques and obtaining sound source location information, it will be possible to stimulate the ICC to elicit some binaural percepts.

The microphone can be worn anywhere on the body and even be directly attached to the processor. It is possible to have several microphones or microphone arrays worn in different locations on the body to increase sound recording performance.

Processor (Sound Processor/Encoder/Transmitter)

The sound that is recorded onto the processor 3 via the microphone 1 needs to be decomposed and encoded into a stimulation sequence that will control how the ICC is stimulated. Once the sound is encoded into a stimulation sequence, it will be converted to a radiofrequency code that will be transmitted via an inductive coil. The transmitter 4 is connected via a cable to the processor and can be magnetically attached to the receiver using a transcutaneous connector. The receiver is a part of the stimulator 5 and can be implanted underneath the skin within a bony well behind the ear posterior to the mastoid. The processor 3 may have an external power source but can also be powered by rechargeable batteries.

Based on our results, frequency-specific information can be transmitted to the auditory cortex by stimulating ICC neurons. Although the exact nature of temporal coding in the ICC is not yet understood, it is also evident from our results that location of stimulation within a given isofrequency lamina will elicit different cortical activation patterns and ultimately different perceptual effects that appear to be correlated with temporal features of sound. Therefore, both frequency and temporal information can be transmitted to the cortex but the type of information transmitted depends on how ICC neurons are stimulated.

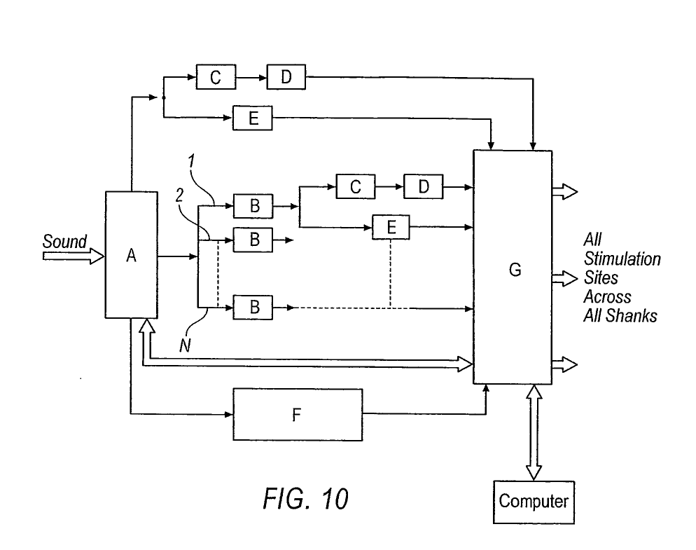

Based on our results and knowledge of the inferior colliculus, we have developed a preferred method for stimulating the ICC. However, this method is only an example that should provide enough insight as to how the ICC could be stimulated and how modifications to this method can be implemented. The decomposition and encoding of the sound will consist of three parts: frequency coding, temporal coding, and group coding. Each part is described in more detail following a brief overview of the diagram presented in FIG. 10.

FIG. 10 presents a simplified flowchart of how frequency coding, temporal coding, and group coding can be performed. The components of the processing strategy in this embodiment may include:

A. A blackbox that decomposes sound into the desired signals dictated by G. For example, sound can be separated into different source signals or left in its original form or denoised to improve signal-to-noise ratio;

B. Band pass filters corresponding to the different frequency channels of the ICC. N total channels;

C. Rectifier filters to convert all values to positive values to activate spikes;

D. Low pass filters to extract temporal envelopes of filtered signals;

E. A blackbox used to extract out different temporal features from the filtered signals important for speech perception and hearing restoration in general that will be used for temporal coding;

F. A blackbox used to extract important features that will be used for group coding, such as for sound localization and source segregation; and

G. A main blackbox that serves several functions, including without limitation:
1. Storing all tuning information and settings obtained from the frequency pitch and temporal features matching sessions with the implantees;
2. Storing which sites elicit what frequency and temporal percepts;
3. Storing which sites respond to modulated and/or unmodulated pulse trains, and what parameters to use;
4. Storing the parameters for current steering and which “virtual” sites elicit what percepts;
5. Processing the filtered signals to determine how to stimulate the sites based on the stored parameters and data;
6. Incorporating the temporal feature data (from E) and group coding data (from F) to determine how to stimulate the sites;
7. Interfacing and controlling blackbox A to process the sound signal in a manner that will extract the appropriate frequency, temporal, and group coding parameters for electrical stimulation; and
8. Interfacing with the computer for updating data and algorithms, as well as transferring data for analysis and optimization;

1. Frequency Coding

For the purposes of extracting the frequency components from the sound input, processing strategies known to those of ordinary skill, as one example only, used for cochlear implants, can be implemented. Basically sound is bandpass filtered into different frequency components (blackbox B). Each of these frequency components gets passed through a rectifier (blackbox C) and then lowpass filtered (blackbox D) to obtain the temporal envelope of the signal. The lowpass cutoff frequency for extracting these envelopes will vary depending on implantee performance. For cochlear implants, the temporal envelope is then multiplied by a gain to account for the loudness and dynamic range effects and used to amplitude modulate biphasic electrical pulses. These electrical pulses are presented to the region along the cochlea corresponding to the same frequency range as used for the bandpass filter. For ICC stimulation however, the type of stimulation pattern will depend on the location of the stimulation site within the isofrequency lamina and the type of information to be presented to that site. This last statement will be better clarified when describing temporal coding in the next section. For now it suffices to state that a certain stimulation pattern will be presented on a given site that may or may not utilize the temporal envelope that has been extracted.

The important feature of frequency coding is that the perceptual effect of stimulating each site will be determined first. After the auditory prosthesis is implanted into the patient, it will be possible to do a frequency pitch matching session with the implantee. This basically consists of stimulating each site with electrical pulse trains and determining what frequency pitch is perceived by the implantee. It is then possible to rank order the sites from a low to high frequency pitch to create a site-to-frequency pitch map. This map may be obtained for each shank since each shank will have its own frequency pitch gradient (each shank is inserted into the ICC so that the sites are aligned along the tonotopic gradient). A single site-to-frequency pitch map can also be obtained across all the shanks and sites to attain a single map with finer and a greater number of frequency increments. In addition to these sites, a site-to-frequency pitch map can be obtained for the “virtual sites” created by current steering along and across the shanks. It is essential to obtain as many frequency channels as possible using the actual and “virtual” sites to improve the spectral quality of signal presented to the implantee.

Based on these maps, the inputted sound can be filtered to extract out its frequency components and determine which sites to stimulate to elicit the desired spectral percepts (blackboxes A-B-C-D-G or A-B-E-G). There are other deviations from this algorithm that can be used and be inferred from this invention. For example, it might be better to create a map for each of the five shanks and then simultaneously stimulate all five sites that elicit similar frequency percepts to more effectively activate a given lamina. It is also possible to stimulate different sites with different delays within a given isofrequency lamina (including “virtual” sites) or across laminae that elicit frequency percepts close to the desired frequency percept. The scope of this invention is to include these different algorithms and modifications to these algorithms.

2. Temporal Coding

As mentioned above, the importance of frequency coding is to determine what frequency components are present in the inputted sound and then stimulate the ICC neurons that will elicit those frequency percepts. The importance of temporal coding addresses how each of those stimulation sites will be temporally stimulated to transmit the temporal features encoded in the firing pattern of the neurons surrounding each site.

In general, the ability of neurons to synchronize to and encode for the temporal periodicities of the sound waveform decreases as one moves higher up along the auditory pathway. In other words, auditory nerve fibers can encode for periodicities as high as 5 kHz while ICC neurons can only encode for periodicities usually up to about 300 Hz with many ICC neurons only encoding up to about 100 Hz (Winer and Schreiner, 2005). Therefore, it does not appear beneficial to stimulate ICC neurons with high pulse rates or even high modulation frequencies for amplitude-modulated pulses. As presented earlier, periodicity also appears to be coded spatially and may partially depend on a rate code representation. This suggests that some neurons may not respond well to amplitude modulated pulse trains but rather encode for amplitude modulation, especially for higher modulation rates, by increasing their firing rate. For these ICC neurons, a pulse sequence that can increase their firing rate would be better suited to encode for a specific modulation or change in temporal waveform.

In order to determine which sites should be stimulated with amplitude-modulated pulse trains and which should be stimulated with unmodulated, possibly randomized, pulse trains a temporal coding session needs to be performed with the implantee. During this session, or through several sessions, different temporal stimulation patterns will be presented on each stimulation site to determine their perceptual significance. The session may be performed after the frequency pitch matching session to have an idea of which sites elicit which frequency percepts. The first step will be to determine the maximum pulse rates to use for each site. This may be determined in conjunction with what maximum modulation rates to use for amplitude-modulated pulse trains. As a starting point, since ICC neurons tend not to synchronize with rates above 100-300 Hz and since most of the temporal variations needed for speech perception can be achieved with rates up to about 50 Hz, the modulation rates can be varied between 50 to 100 Hz. This is not to limit the range, but just to use as a starting point. The pulse rates can vary, but they may prove to be unimportant since cochlear implant stimulation studies have shown that for amplitude-modulated pulse trains presented to the cochlea, ICC neurons synchronize to the modulation rate while being insensitive to the pulse train rate. After determining which sites produce temporal percepts to amplitude-modulated pulse trains that may or may not elicit intelligible speech percepts, it will be important to categorize the perceptual effects of stimulating the other sites with unmodulated pulse trains. More complicated time-varying pulse trains can also be used to elicit different percepts. The important feature is to determine if there exists a systematic shift in modulation percept, as well as other percepts such as those correlating with the rising and falling changes in the waveform amplitude with different slopes, as one stimulates different sites along both the frequency and isofrequency dimension. It may be possible that some ICC neurons are sensitive to both modulated and unmodulated pulse trains. Since the ICC is proposed to have a periodotopic map orthogonal to the tonotopic map, systematic spatial stimulation to elicit different modulation percepts appear to be achievable in the ICC or at least the ability to elicit different temporal percepts. These different temporal percepts can also be determined for the “virtual” sites by stimulating across and along shanks, and even between just two sites.

As shown in FIG. 10, several different stimulation options are available for each site. Blackbox G represents the component that can be used to incorporate what has been learned from the frequency pitch and temporal feature matching sessions and determine what sites to stimulate and in what pattern depending on the sound information recorded. If a given site responds to amplitude-modulated pulse trains, then after the temporal envelope is extracted as explained in the frequency coding section (blackboxes A-B-C-D), it can be used to amplitude-modulate electrical pulse trains on that site. If the site is more sensitive to unmodulated pulse trains, then depending on the periodicities within the extracted temporal envelope the site may or may not be stimulated. This will depend on the other four sites that are located within the same isofrequency lamina. Since it is possible that each of the five sites elicit different periodicity percepts, depending on what periodicities are present within that temporal envelope (which can also include higher periodicities by using a higher lowpass cutoff frequency), the different sites will be stimulated accordingly to match the time changing envelope. In addition, Blackbox E can be used to extract out other temporal features of the filtered sound components, including rising and falling changes in amplitude with different slopes, to determine what sites to stimulate and in what pattern. It is possible that rather than encode for the temporal envelope of the bandpassed signal, it is more appropriate to encode for the temporal envelope or temporal features of the original signal (blackboxes A-C-D-G or A-E-G). In this case, the original signal can be processed and depending on what periodicities or temporal variations exist within that signal, different sites across the entire electrode, not just within a given lamina, can be stimulated accordingly. It may be possible that a site is sensitive to both modulated and unmodulated pulse trains, and in this case can be used for either depending on the temporal content of the sound waveform.

In essence, temporal coding is used in conjunction with frequency coding to dictate what sites along a given isofrequency lamina and how each of these sites will be temporally stimulated. The frequency coding will dictate which sites across the entire electrode array will be stimulated to elicit the desired frequency percepts.

3. Group Coding

A limitation with cochlear implants is that it is difficult to transmit information to higher auditory centers relating to where the sound originated from and what sources exist within the sound. Since the inferior colliculus resides high enough along the auditory pathway where binaural information and source segregation are encoded, it will be possible to elicit some of these percepts by stimulating in the ICC.

Using the microphone arrays, it will be possible to isolate some of the sources present in the sound and where these sources are spatially originating from. Since different sources tend to exhibit different periodicities within their waveform, it will be possible to decompose the original recorded signals into separate source signals, each consisting of different periodicities. For example, there could be two speakers in a room with some background noise. One speaker could be a child who would create a sound with higher periodicities, or a higher pitch effect, compared to the other speaker who could be an adult male. They may be saying the same sentence, thus producing sound waveforms with similar spectral content but with different periodicities. The microphones would simultaneously record the sound from both speakers, including the background noise. Blackbox A of the processor would then separate them into three different signals. The processor would then perform the routine frequency coding and temporal coding on each of these signals. It may be more advantageous to exclude the background noise if it has no perceptual merit. At this point, it will be important to determine what sites to stimulate in the ICC to elicit the percept of two different speakers and also to elicit where those speakers are located in space.

As performed with the frequency coding and temporal coding sessions, another session or sessions will need to be performed to determine if sites can be grouped together based on periodicity pitch. If in fact a systematic map of periodicity pitch exists within the ICC orthogonal to the tonotopic map, it may be that a single shank corresponds to all the frequencies for a given periodicity while another shank corresponds to all the frequencies for another periodicity. In this sense, it may be possible to stimulate one shank independently from the other shank to elicit the percept of two different speakers. The grouping may be more complicated then this and will need to be determined from psychophysical studies with the implantees.

In a similar manner, it will be possible to determine if stimulation of a group of sites all elicit a percept of a sound coming from one direction while stimulation of another group of sites elicits a percept that a sound is coming from another direction. There are different regions within the ICC that respond to different binaural features of sound. Some regions are more sensitive to binaural inputs while other regions are more sensitive to just monaural information. Therefore, it will be useful to determine which sites can be used to induce binaural percepts and how those sites might be stimulated to elicit a systematic change in source location perception. Based on cortical studies, source location appears to be represented in a distributed manner across populations of neurons (Stecker and Middlebrooks, 2003). Similar coding of space may also exist in the ICC requiring simultaneous stimulation of populations of neurons within the ICC to elicit different sound location percepts.

Group coding can be further modified to incorporate other aspects of sound that may involve simultaneous stimulation of all the sites in different spatial and temporal patterns or by separating all the sites into distinct groups of sites that are activated in their own way within each group. These other aspects of sound can be determined by performing further psychophysical studies with implanted patients and can be implemented via blackbox F.

Stimulator (Receiver/Decoder/Stimulator)

The stimulator 5 consists of a radiofrequency receiver that receives the radiofrequency code from the transmitter. The radiofrequency code can use frequency modulation (FM) signals. The stimulator is implanted within the skull, as one possible example only, within a bony well in the bone behind the ear posterior to the mastoid of the implantee. The stimulator can be powered via transcutaneous induction from the processor 3. The stimulator will then decode the radiofrequency code and stimulate the electrode accordingly. The pulse parameters will vary from patient to patient. The pulse duration can range from 10 to 400 μsec. The pulses will be biphasic and charge-balanced. They can by symmetrical or asymmetrical if it is desired to alter how fibers versus cells are activated.

The stimulator will be connected to the stimulating electrode 7 via wires 17. The wires will be permanently connected to the stimulating electrode and it is possible to design the system such that the wires can be permanently connected to the stimulator as well. However, another embodiment would be to have the wires detached from the stimulator to allow the surgeon to replace the stimulator if needed in the future without having to explant the stimulating electrode. This will provide some flexibility but will create an additional step during the surgery where the surgeon will have to connect the wires himself/herself

Methods for Placement and Implementation of Some Embodiments of the Invention:

The methods and system designs for implementing the midbrain auditory prosthesis proposed in this patent are to serve as examples of how to develop and implement this invention without limiting the scope of this invention.

In implanting the stimulating electrode 7 into the inferior colliculus 11, many techniques for deep brain stimulation that are known to those of ordinary skill in the art can be applied. It will be possible to use magnetic resonance imaging (MRI) to determine the general location and stereotaxic coordinates of the inferior colliculus. The implantee's head can be mounted onto a stereotaxic frame that will be used to position and insert the stimulating electrode into the inferior colliculus. Similar to deep brain stimulation procedures, the electrode can be inserted into the inferior colliculus through a burr hole. Once in correct position, the electrode can be fixed to the head to detach the electrode from the stereotaxic frame. There are other techniques available (personal communication with surgeons). These include a medial sub-occipital (infratentorial-supracerebellar) approach and a modified lateral sub-occipital approach. The latter can be used after the removal of an acoustic neuroma, as is the case for neurofibromatosis type II patients. The procedure will occur after the removal of the tumor and within the same surgical setting, except for the added step of exposing the inferior colliculus by retracting down the cerebellum and using a medially-extended, lateral sub-occipital approach. The electrode can then be inserted into the inferior colliculus where the direction of penetration will be approximately perpendicular to the isofrequency laminae of the ICC. The electrode wires will then extend out to the stimulator from an opening in the dura. In cases where tumor removal is not necessary or for patients who cannot achieve the desired level of performance from cochlear implants, a medial sub-occipital approach can be performed where the cerebellum is retracted downwards allowing for direct visualization of the inferior colliculus. The electrode can then be inserted into the inferior colliculus under direct vision, where the direction of penetration will also be approximately perpendicular to the isofrequency laminae of the ICC. The electrode wires can then extend out to the stimulator from an opening in the dura.

Since the electrode will consist typically of several shanks, it may be necessary to fabricate an inserter that will insert the electrode with the appropriate speed and force to minimize tissue damage and compression. This inserter device can be attached to the stereotaxic device as well as be held by the surgeon during manual insertion.

An important requirement during surgical implantation of the electrode is to ensure that the shanks of the electrodes are inserted perpendicular to the isofrequency laminae of the ICC and that most or all of the shanks are located within the ICC. For the first implantations, it may be necessary to use a single-shank probing electrode to stimulate different regions of the inferior colliculus in an awake, locally anesthetized implantee in order to determine the border of the ICC based on psychophysical responses from the patient. Once the borders are determined, the stimulating electrode can be inserted. After several implantations, it may be possible to determine visual landmarks, including blood vessel organization, to aid in correctly placing the electrode in future patients. The benefit of inserting a multi-shank electrode is that there is a higher probability of inserting shanks into the ICC compared to a single shank electrode. In relation to tissue damage and surgical risk, the stimulating electrode may only be able to be inserted a single time. Assessment of tissue damage and risk will need to be performed to determine if the electrode can be re-inserted if it is not in an ideal location.

In order to determine if the electrode is within an ideal location, several methods are possible. It is possible to perform the stereotaxic surgery in an awake, locally anesthetized patient, similar to what is currently done for deep brain stimulation patients. In this way, it will be possible to place the electrode and perform psychophysical tests to determine if the patient perceives the desired frequency and temporal percepts for all or some of the sites. Based on the assessment, it will be possible to determine how many sites are within the ICC and if the overall placement of the electrode within the ICC is acceptable. However, the mental and emotional stress for the patient in being awake during this surgery does not make this method appealing.

Another proposed method is based on our recent findings dealing with the systematic change in evoked potential magnitudes recorded in A1 as a function of stimulation location along the rostrocaudal isofrequency dimension of the ICC (see FIG. 7 and related discussion above). In general, stimulation of more rostral regions along the isofrequency dimension of the ICC elicited stronger evoked potentials in Al. Although this data was taken from a guinea pig animal model, due to the similarities across mammalian midbrain anatomy and physiology, it seems likely that some systematic pattern of evoked potential activation will exist by stimulating different locations within the human ICC as well. This systematic activation pattern can be used to determine the location of each site within an isofrequency lamina in the ICC. The benefit of this method is that the evoked potential can be noninvasively recorded on the surface of the head above the auditory cortex in response to stimulation of each electrode site within the ICC. Therefore this data can be readily collected during implantation and also across implanted patients to initially determine this evoked potential map.

As shown in FIG. 7, the magnitude of the evoked potential recorded in A1 increases as one stimulates more rostrally along an isofrequency lamina in the ICC. Across patients, the absolute value of these magnitudes may fluctuate. However, the relative value of evoked potentials (the ratio of evoked potential magnitudes between sites) will provide a more robust measure across patients for indicating the approximate location of each site along the isofrequency dimension of the ICC. This is another benefit of using a multi-shank electrode. A single shank electrode will only have a single site within each lamina so it will be difficult to determine from the one evoked potential recorded where that stimulated site is located within the ICC lamina. It should also be noted that evoked potential magnitude doesn't necessarily correlate with the best location. It is possible that for larger evoked potentials, the psychophysical threshold will be lower for a given stimulation site. In this sense, a large evoked potential elicited by stimulating a given site will indicate that the site is in a good location. However, as shown in FIG. 7, we obtain the largest evoked potentials by stimulating in the rostral region of the ICC, but those sites also produce the greatest spread of activation across frequency channels (see FIG. 6 and related discussion above). During surgery, it may be more optimal to place the sites in a more central region within an isofrequency lamina that balances the evoked potential magnitude with the extent of spreading. The only way one can know if the evoked potential magnitude elicited does in fact correlate with a middle ICC region is to stimulate several sites within that lamina, compare the evoked potential ratios, and determine the approximate ICC location based on the evoked potential ratio map obtained from previous implantees.

This application may reference various publications by author and/or by patent number, including without limitation, articles, presentations, and United States patents. The disclosures of each of these references in their entireties are hereby incorporated by reference into this application.

While the present invention has been particularly shown and described with reference to the foregoing preferred and alternative embodiments, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

### REFERENCES

Anderson D J, Najafi K, Tanghe S J, Evans D A, Levy K L, Hetke J F, Xue X, Zappia J J, Wise K D. Batch-fabricated thin-film electrodes for stimulation of the central auditory system. IEEE Trans. Biomed. Eng. 36(7): 693-704, 1989.

Bai Q, Wise K D, Anderson D J. A high-yield microassembly structure for three-dimensional microelectrode arrays. IEEE Trans. Biomed. Eng., 47:281-289, 2000.

Bierer J A, Middlebrooks J C. Auditory cortical images of cochlear-implant stimuli: Dependence on electrode configuration. J. Neurophysiol. 87(1): 493-507, 2002.

Boockvar J A, Telfeian A, Baltuch G H, Skolnick B, Simuni T, Stem M, Schmidt M L, Trojanowski J Q. Long-term deep brain stimulation in a patient with essential tremor: Clinical response and postmortem correlation with stimulator termination sites in ventral thalamus. J. Neurosurg. 93(1):140-144, 2000.

Friesen L M, Shalmon R V, Baskent D, Wang X. Speech recognition in noise as a function of the number of spectral channels: Comparison of acoustic hearing and cochlear implants. J. Acoust. Soc. Am. 110(2): 1150-1163, 2001.

Geniec P, Morest D K. The neuronal architecture of the human posterior colliculus. Acta. Otolaryngol. Suppl. 295: 1-33, 1971.

Gingerich M D, Hetke J F, Anderson D J, and Wise K D. A 256-Site 3D CMOS microelectrode array for multipoint stimulation and recording in the central nervous system. Int. Conf. Solid-State Sensors and Actuators (Transducers '01) Munich, June 2001.

Langner, G. Topographic representation of periodicity information: The 2^{nd} neural axis of the auditory system. In: Syka J and Merzenich M M (eds). Plasticity of the Central Auditory System and Processing of Complex Acoustic Signals. Springer-Verlag, New York pp. 19-33, 2004.

Lim H H, Anderson D J. Feasibility experiments for the development of a midbrain auditory prosthesis. Proc. ^{st} Int. IEEE EMBS Conf. Neural Eng., Capri, Italy, pp. 193-196, March 2003.

Loftus W C, Bishop D C, Saint Marie R L, Oliver D L. Organization of binaural excitatory and inhibitory inputs to the inferior colliculus fi-om the superior olive. J. Comp. Neurol. 472: 330-344, 2004.

Moore J K. The human auditory brainstem: A comparative view. Hear. Res. 29: 1-32, 1987.

Otto S R, Brackmann D E, Hitselberger W E, Shannon R V, Kuchta J. Multichannel auditory brainstem implant: Update on performance in 61 patients. J. Neurosurg. 96(6): 1063-1071, 2002.

Rodenhiser K L, Spelman F A. Quadrupolar stimulation for cochlear prostheses: Modeling and experimental data. IEEE Trans. Biomed. Eng. 43(8): 857-865, 1996.

Stecker G C, Middlebrooks J C. Distributed coding of sound locations in the auditory cortex. Biolog. Cybernet. 89(5): 341-349. 2003.

Winer J A, Schreiner C E. The Inferior Colliculus. Springer Science+Business Media, Inc., New York, 2005.

Wise K D, Anderson D J, Hetke J F, Kipke D R, Najafi K. Wireless implantable microsystems: High density electronic interfaces to the nervous system. Proc. IEEE, 92:76-97, 2004.

1. An auditory prosthesis system comprising:
a microphone,
a sound processor,
a current stimulator, and
at least one stimulating electrode disposed in the inferior colliculus of a mammal, the at least one stimulating electrode comprised of at least two shanks, each shank comprised of one or more stimulation sites.

2. The auditory prosthesis system of claim 1, each shank being from 3 to 7 millimeters in length.

3. The auditory prosthesis system of claim 1, comprised of one stimulating electrode disposed in the inferior colliculus of a mammal, the electrode having five shanks, each shank having from 10 to 80 stimulation sites.

4. The auditory prosthesis system of claim 3, wherein the stimulation sites on each shank are linearly spaced from 50 to 400 micrometers apart.

5. The auditory prosthesis system of claim 1, wherein each stimulation site has a surface area from 400 to 4000 square micrometers.

6. The auditory prosthesis system of claim 1, wherein each stimulation site has a surface area of 2000 square micrometers.

7. The auditory prosthesis system of claim 1, comprised of at least one stimulating electrode having five shanks, each shank having 20 stimulation sites, each stimulation site linearly spaced 200 micrometers apart.

8. The auditory prosthesis system of claim 1, comprised of at least one stimulating electrode having five shanks, each shank having 40 stimulation sites, each stimulation site linearly spaced 100 micrometers apart.

9. The auditory prosthesis system of claim 1, comprised of two or more stimulation sites configured for stimulation across and within different isofrequency laminae of the central nucleus of the inferior colliculus.

10. The auditory prosthesis system of claim 1 comprised of two or more stimulation sites configured for stimulation at different locations within the same isofrequency lamina of the central nucleus of the inferior colliculus.

11. The auditory prosthesis system of claim 1, wherein the system differentially extracts one or more frequency components of a sound wave and differentially stimulates one or more regions of the inferior colliculus.

12. The auditory prosthesis system of claim 11, wherein the differential stimulation of the inferior colliculus is done by current steering.

13. The auditor prosthesis system of claim 1, wherein the microphone comprises a directional microphone.

14. The auditor prosthesis system of claim 1, wherein the microphone comprises an array of microphones.

15. The auditor prosthesis system of claim 1, wherein the current stimulator comprises an induction coil for receiving a radiofrequency signal from the processor.

16. An auditory prosthesis system comprising:
a microphone,
a sound processor comprising an encoder and a transmitter,
a current stimulator that is implanted in a mammal and that comprises a receiver, and at least one stimulating electrode disposed in the inferior colliculus of the mammal, the electrode comprised of at least two shanks, each shank comprised of one or more stimulation sites,
wherein the microphone senses sound vibrations and transmits a sound waveform to the sound processor,
the sound processor decomposes the sound waveform into a stimulation sequence signal that is transmitted to the current stimulator,
the current stimulator receives the stimulation sequence signal transmitted by the processor, decodes the signal into a differential stimulation sequence, and transmits the sequence to one or more stimulation sites on the stimulating electrode.

17. The auditory prosthesis system of claim 16, wherein the sound processor comprises an inductive coil, the current stimulator comprises a radiofrequency receiver, and the signal transmitted by the sound processor to the current stimulator is a radiofrequency signal.

18. The auditory prosthesis system of claim 16, wherein the current stimulator is powered by transcutaneous induction from the sound processor.

19. The auditory prosthesis system of claim 16, wherein the current stimulator and at least one stimulating electrode are connected by wire.

20. The auditory prosthesis system of claim 16, wherein the transmission of the stimulation sequence from the current stimulator to at least one stimulating electrode occurs wirelessly.

21. The auditory prosthesis system of claim 16, wherein the transmitter portion of the sound processor and the implanted current stimulator are held together magnetically across a biological membrane of the mammal.

22. The auditory prosthesis system of claim 16, wherein the system differentially extracts one or more frequency components from sound waves and differentially stimulates one or more regions of the inferior colliculus of the mammal.

23. The auditory prosthesis system of claim 16, wherein the processor decomposes the sound waveform by at least one of frequency coding, temporal coding, and group coding.

24. A method of inducing auditory sensation in a mammal, comprising the steps of:
providing a microphone, a sound processor, and a current stimulator;
providing one or more stimulating electrodes each comprised of two or more shanks, each shank comprised of one or more stimulation sites;
disposing at least one stimulating electrode in the inferior colliculus of a mammal; and
stimulating at least one isofrequency lamina of the inferior colliculus by applying an electrical signal through at least one of the stimulation sites.

25. The method of claim 24, wherein the stimulating electrode is disposed by insertion perpendicular to at least one isofrequency laminae of the central nucleus of the inferior colliculus such that one or more stimulation sites are aligned along a tonotopic axis of the central nucleus.

26. The method of claim 24, wherein the stimulating step comprises frequency coding, temporal coding, and group coding.

27. The method of claim 24, wherein two or more stimulation sites are configured for stimulation across and within different isofrequency laminae of the central nucleus of the inferior colliculus.

28. The auditory prosthesis system of claim 24, wherein two or more stimulation sites are configured for stimulation at different locations within the same isofrequency lamina of the central nucleus of the inferior colliculus.

29. A method of inducing auditory sensation in a mammal, comprising the steps of:
providing a microphone, a sound processor comprising an encoder and a transmitter a sound processor, and a current stimulator that is implanted in a mammal and that comprises a receiver,
providing at least one stimulating electrode, the electrode comprised of at least two shanks, each shank comprised of one or more stimulation sites,
disposing at least one stimulating electrode in the inferior colliculus of a mammal; and
differentially stimulating at least one isofrequency lamina of the inferior colliculus by applying an electrical signal through at least one of the stimulation sites,
wherein the microphone senses sound vibrations and transmits a sound waveform to the sound processor,
the sound processor decomposes the sound waveform into a stimulation sequence signal that is transmitted to the current stimulator,
the current stimulator receives the stimulation sequence signal transmitted by the processor, decodes the signal into a differential stimulation sequence, and transmits the sequence to one or more stimulation sites on the stimulating electrode.

30. The method of claim 29, wherein the sound processor comprises an inductive coil, the current stimulator comprises a radiofrequency receiver, and the signal transmitted by the sound processor to the current stimulator is a radiofrequency signal.

31. The method of claim 29, wherein the current stimulator is powered by transcutaneous induction from the sound processor.

32. The method of claim 29, wherein the current stimulator and at least one stimulating electrode are connected by wire.

33. The method of claim 29, wherein the transmission of the stimulation sequence from the current stimulator to at least one stimulating electrode occurs wirelessly.

34. The method of claim 29, wherein the transmitter portion of the sound processor and the implanted current stimulator are held together magnetically across a biological membrane of the mammal.

35. The method of claim 29, wherein the system differentially extracts one or more frequency components from sound waves and differentially stimulates one or more regions of the inferior colliculus of the mammal.

36. The method of claim 29, wherein the processor decomposes the sound waveform by at least one of frequency coding, temporal coding, and group coding.

37. The method of claim 29, wherein two or more stimulation sites are configured for stimulation across and within different isofrequency laminae of the central nucleus of the inferior colliculus.

38. The method of claim 29, wherein two or more stimulation sites are configured for stimulation at different locations within the same isofrequency lamina of the central nucleus of the inferior colliculus.

39. An auditory prosthesis system comprising:
a microphone,
a sound processor,
a current stimulator, and
at least one stimulating electrode disposed in the inferior colliculus of a mammal, the at least one stimulating electrode comprised of at least one shank having one or more stimulation sites.

40. A method of inducing auditory sensation in a mammal, comprising the steps of:
providing a microphone, a sound processor, and a current stimulator;
providing one or more stimulating electrodes comprised of one or more shanks, each shank comprised of one or more stimulation sites;
disposing at least one stimulating electrode in the inferior colliculus of a mammal; and
stimulating at least one isofrequency lamina of the inferior colliculus by applying an electrical signal through at least one of the stimulation sites.
